(19) United States
(12) Patent Application Publication
(10) Pub. No.: US 2002/0116294 A1
(43) Pub. Date: Aug. 22, 2002

(54) Desktop document control manager

(75) Inventors: Peter Ranck, Thousand Oaks, CA (US); Dipanjan Chatterjee, Newbury Park, CA (US)

Correspondence Address: Mr. Steven W. Smyrski, PILLSBURY WINTHROP LLP, 725 South Figueroa Street, Suite 2800, Los Angeles, CA, 90017, US

(73) Assignee: Kinko's Ventures, Inc.

(21) Appl. No.: 09/789,282

(22) Filed: Feb. 20, 2001

(51) Int. Cl. G06F 17/60; G06F 15/00; G06F 17/00; G06F 17/21; G06F 17/24

(52) U.S. Cl. 705/27; 707/530

(57) ABSTRACT

A method for conducting business for use by a retailer is disclosed. The method comprises offering computer access to a user and employs a series of menus and submenus directed to business commonly conducted by visitors to the retailer. An embodiment of the menu arrangement includes a top level menu having various areas located thereon, including a selectable area which offers navigation to submenus, programs, or other related locations, a space for promotional information, a space for advertising information, and a title. The top level menu may include a search field for searching the menus and submenus offered, and may include a selectable section for accessing email or the internet. The user is offered access to certain items, such as a password and storage space maintained by the retailer, that can permit the user to conduct business outside the retail location and store material or information with the retailer to facilitate return business conducted by the visitor.

### BACKGROUND OF THE INVENTION

1. Field of the Invention

The present invention relates to the art of computing systems, and more particularly to software and methods for directing users to specific software programs based on a preferred desired task, such as document production.

2. Description of the Related Art

Computer users typically have varying ranges of capabilities and familiarity with different types of software programs. New users may, for example, know how to use e-mail but not Adobe Illustrator, or Microsoft Word but not Microsoft Power Point. Advanced users may know many, but not all types of software programs and may have no knowledge of software that would facilitate certain tasks. Coupled with this variety of experience levels on computer software is the fact that certain users may wish to accomplish various goals using software currently available on the market and not know which program or programs may be available or best designed to accomplish the desired task.

Certain persons wishing to accomplish specific tasks go to particular locations to accomplish those tasks and use borrowed or rented computers at the facility. A typical example of this is a user wishing to prepare a complex bound document or a set of formal invitations. While certain typesetters and document production facilities are available for these tasks, the advent of sophisticated computer programs enables a user to save time and money performing document production jobs at a retail store location. A user simply goes to a retail store type location, rents a computer, prepares her document to her satisfaction, and prints the document using the retail establishment's advanced equipment, such as binding equipment, photographic quality printers, and so forth.

The problem with the user employing rental equipment at the retail location is that a user may have familiarity with some of the software available but not all of it, or may no some parts of programs but not others. For example, a user may have advanced knowledge of a word processing program, such as Microsoft Word, but not have prepared a document for binding and may not be familiar with printer settings for a bound document within the Word program. Users tend to use programs and features they know, and the end product may not be what the user desires, which creates waste and requires reworking by professionals familiar with the program and particular advantageous features thereof. This is counter to the user's initial intent, namely to save time and money, and can tend to frustrate users.

A user coming to a retail location and renting a computer typically sits down and is presented with a computer desktop interface, with programs either available on the screen, or in the case of Microsoft Windows, accessible through the Start button. The user may or may not fully appreciate the suite of programs available, and may or may not use the programs presented based on preconceptions about the ability of the programs presented or his or her familiarity with the programs presented. Further, a rental computer in such a retail facility may have an expensive program loaded thereon that is not used frequently, such as less than once a year. It would therefore be advantageous to only offer those programs useful in accomplishing a user's particular goal.

Also in the retail/rental computer environment, a user may frequent the particular retailer and constantly produce the same type or types of end products, such as a user who constantly produces manuscripts for consideration by publishers. Such a user may frequent the retailer but do so at different physical locations, or stores. It would be desirable for such a user to have storage of parameters available so he or she would not have to begin anew each time he or she visits one of the retailer's stores.

It is therefore an object of the current invention to provide software or a method enabling computer users to accomplish an ultimate task more efficiently than by using methods previously known.

It is a further object of the current invention to provide computer users in a retail environment with a useful subset of tools available for accomplishing a desired task, i.e. an intelligently partitioned subset of available methods or programs based on the expected tasks that may be useful to the user in the particular environment.

It is yet a further object of the current invention to provide a way for visitors of a retail establishment to maintain a set of personal attributes, files, or other information such that repeat visits to the retail establishment do not require recreating predetermined attributes, files, or other information.

### SUMMARY OF THE INVENTION

According to the current invention, there is provided a method for conducting business for use by a retailer, comprising offering computer access to a user and a series of menus and submenus directed to business commonly conducted by visitors to the retailer. An embodiment of the menu arrangement includes a top level menu having various areas located thereon, including a selectable area which offers navigation to submenus, programs, or other related locations, a space for promotional information, a space for advertising information, and a title. The top level menu may include a search field for searching the menus and submenus offered, and may include a selectable section for accessing email or the internet. It is contemplated that each user will be assigned an account, password, email address, and temporary storage space by the retailer when visiting the retailer. These parameters can permit the user to conduct business outside the retail location and store material or information with the retailer to facilitate return business conducted by the visitor.

While the present invention may be used by any retailer desiring to facilitate business conducted by its visitors, it is particularly suited to document production and printing retailers and the embodiment described herein is explained for that scenario. It is understood that other retailers may employ the invention to particularly direct their customers to computer programs and services that would enable the visitors to complete tasks quickly and efficiently.

The choices offered to the user in the top level menu may, when selected, direct the user directly to programs, or to submenus or preselected templates. Submenus in one embodiment employ the same general design and styling as the top level menu, and include further selections directing users or customers to facilities, options, or services offered by the retailer and helpful in performing tasks relating to the retailer's business. In the document production environment, creating, editing, and printing documents are offered, in addition to templates, career resources, and so forth.

These and other objects and advantages of the present invention will become apparent to those skilled in the art from the following detailed description of the invention and the accompanying drawings.

### DESCRIPTION OF THE DRAWINGS

FIG. 1 presents a conceptual drawing of the computer hardware used in an embodiment of the current invention;

FIG. 2 illustrates a general conceptual drawing of an embodiment of the top level menu in accordance with the teachings of the current invention;

FIG. 3 is an embodiment of the top level menu in accordance with the current invention;

FIG. 4 is a submenu directed toward a document center aspect of an embodiment of the current invention;

FIG. 5 is a submenu directed toward a business resources aspect of one embodiment of the current invention; and

FIG. 6 presents a submenu directed toward a career center aspect of one embodiment of the current invention.

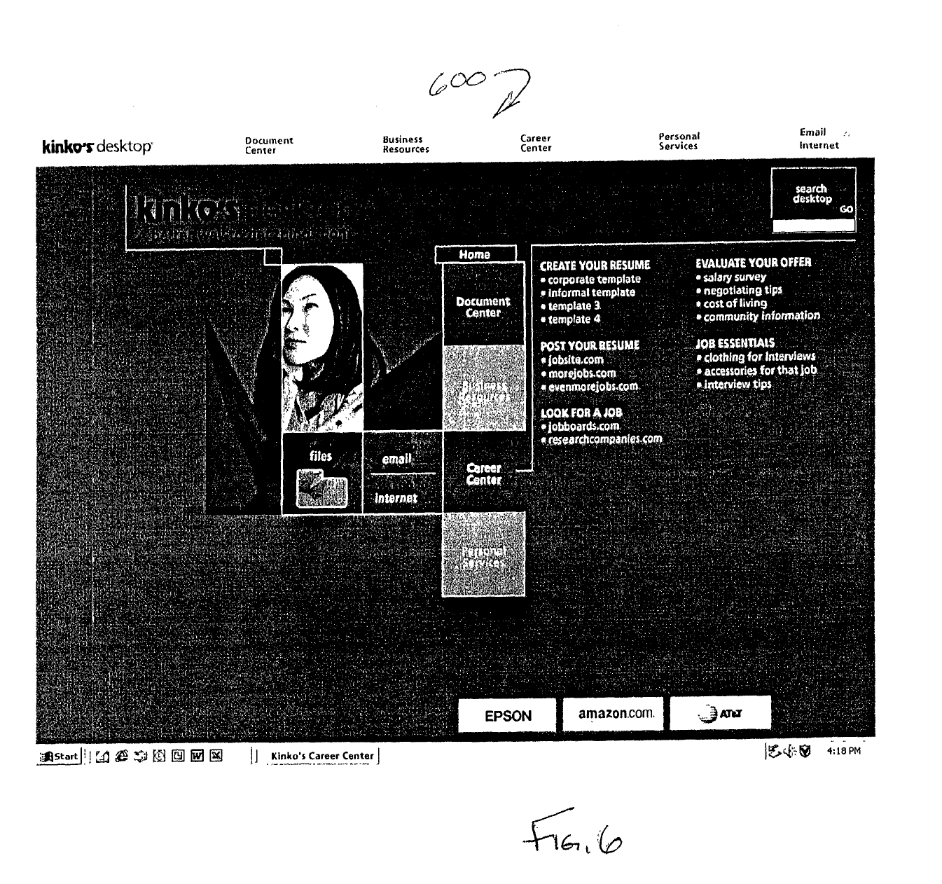

### DETAILED DESCRIPTION OF THE INVENTION

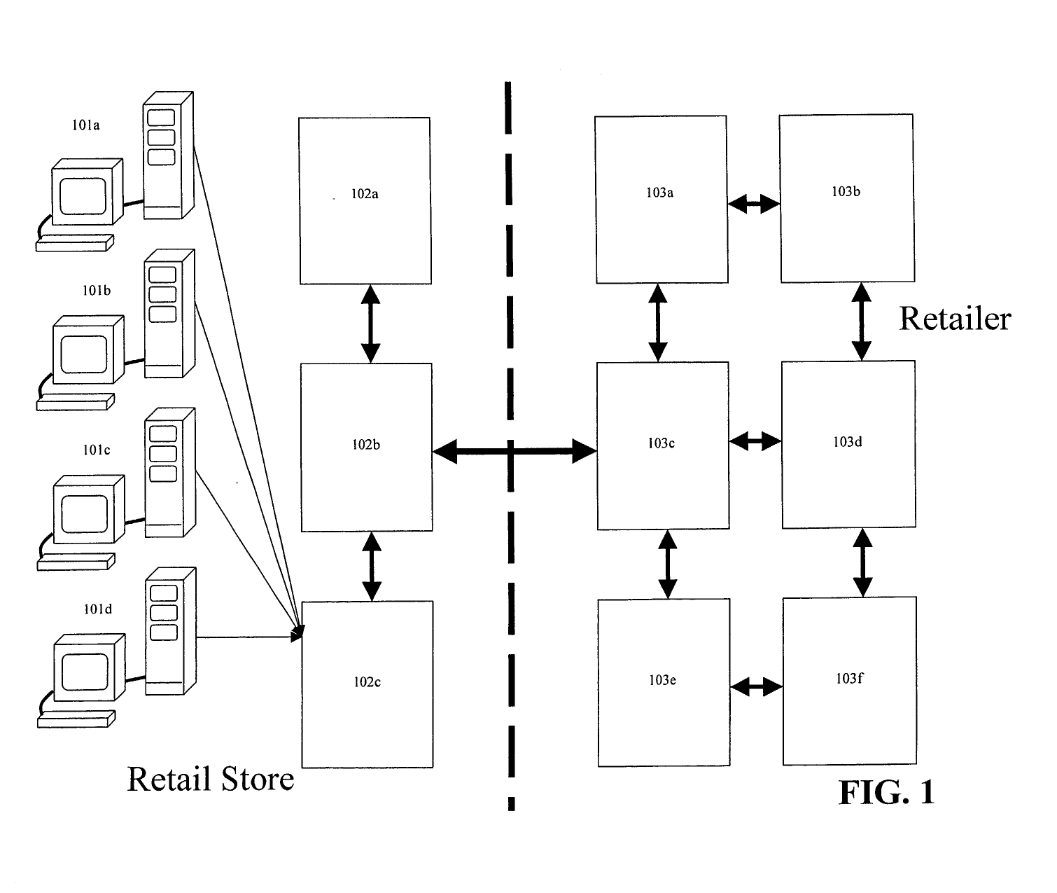

FIG. 1 presents a general illustration of a retail environment employing computers which are available, either generally or for rental, to retail consumers. Personal computer or workstation 101 connects to a central retail store server 102, which in turn connects with a series of servers 103 maintained by the retailer. Each of these servers in the series of servers 103 may or may not be connected to retail store computers. Each of these servers in the series of servers 103 may operate to facilitate other associated functions, such as facilitating storage, financial transactions, data transfer, or other necessary functions.

While the present embodiment is described in the context of a retail printing establishment including a retailer having many retail locations, it is to be understood that the current invention may apply to any environment wherein a computer user encounters a series of submenus or computer programs at a location and the entity offering computer access at the location wherein the retailer wishes to offer limited functionality or access relating to those programs.

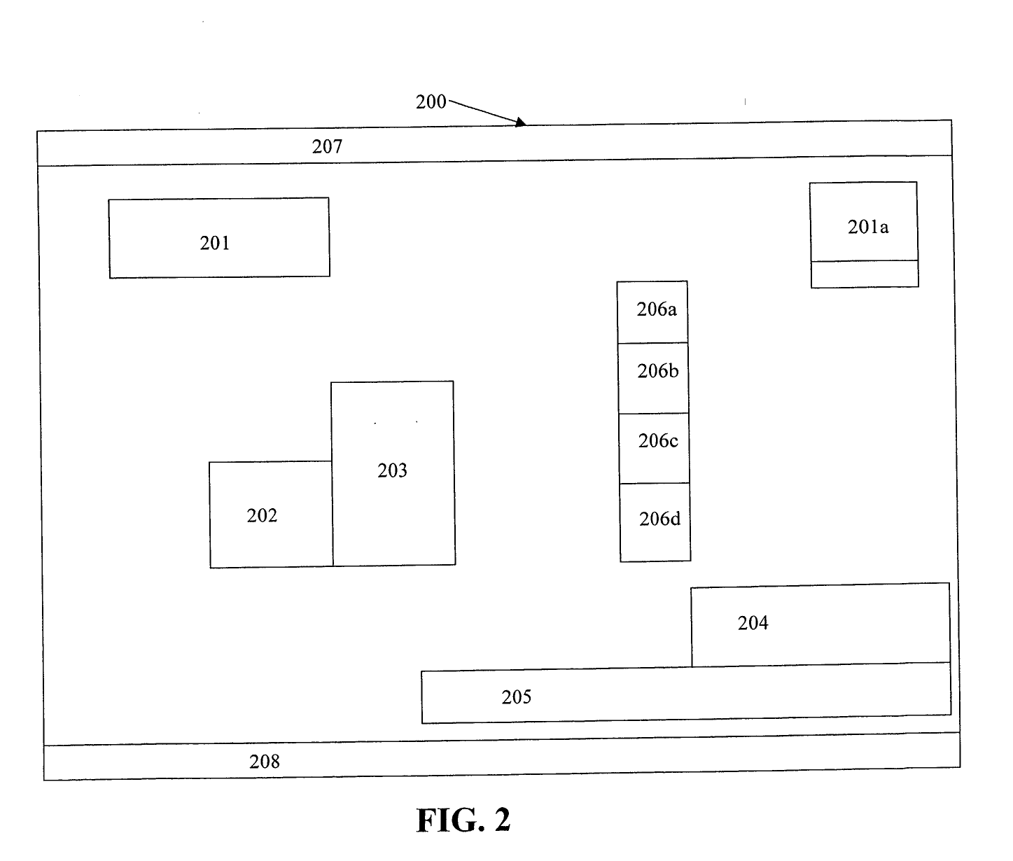

A user in the present embodiment is presumed to arrive at the retailer and obtain access to a computer, either by rental or otherwise, with the desire to perform a printing task. When the retail user sits at a computer terminal, that user encounters an interface, or “home” page screen having the components illustrated in FIG. 2. The top level desktop 200 offers the title 201 of the particular page. The user may optionally be presented with a search capability via search space 201a, wherein the search is directed to subsequent pages and/or capabilities available to the user. For example, the user may wish to find “binding” options for her documents, and by searching for that term be directed to different binding options, binding related pages, or other relevant information. The search engine is a typical HTML or database search engine used to locate and display relevant information in a relatively short period of time. The user is also presented with a file storage area 202, described below, and directional or transition area 203, for directing the user to external services, such as the internet or email. The page can include promotional space 204, and advertising space 205. Promotional space 204 is provided for offering the user certain promotions, from the retailer or third party sources, while advertising space is space for advertising opportunities for the user, whether an internet advertisement, retailer advertisement, or other advertisement. Selection of a link or icon in the promotional space causes the user to be directed to a page or web site, depending on the coding of the link, representing the particular promotional offer desired. An example of such a promotional offer would be the ability for the user to obtain additional computer rental time from the retailer for visiting the retailer's web site, or travel, retail, or other promotional offers. A user selecting an advertisement icon or banner from the advertising section 205 directs the user to an advertisement page or an advertisement on the internet, or a particular web site.

Operational space 206 provides the user with the ability to access particular information and programs directed toward what he or she intends to accomplish using the computer in the retail establishment. In the case of this embodiment, the retail printing environment, the user typically intends to prepare and finalize a document, and send that document to an appropriate printer for printing. The user may also wish to have the document collated, bound, and may wish to have the document stored or sent via the internet. The operational space 206 therefore may consist of various sub spaces, including but not limited to a creation space 206a, a document management space 206b, a publish space 206c, and a resume builder space 206d. Depending on the services offered or desires of consumers, additional or different spaces may be included within the operational space 206.

Typical user interface parameters are included with the top level desktop 200, such as a retailer specific toolbar 207 having selectable buttons directing the user to the submenus and a general toolbar 208 enabling the user to execute available programs, commands, or items.

A user selecting one of the aforementioned subspaces in the operational space may be directed to either a subsequent page or to a particular program, such as a word processing program. In the case of, for example, creation space 206a, the user may be directed to a top level document creation space template screen, offering the user the ability to create a new document, create a specific type of document, such as a resume, or print a document in a specific manner. The user may also be directed to a series of templates or other document related options so that he or she can create a document in a preferred manner. Selection of one of the options presented in one of these submenus may direct the user to another submenu or an operational program or an operational program having predetermined information, such as a template.

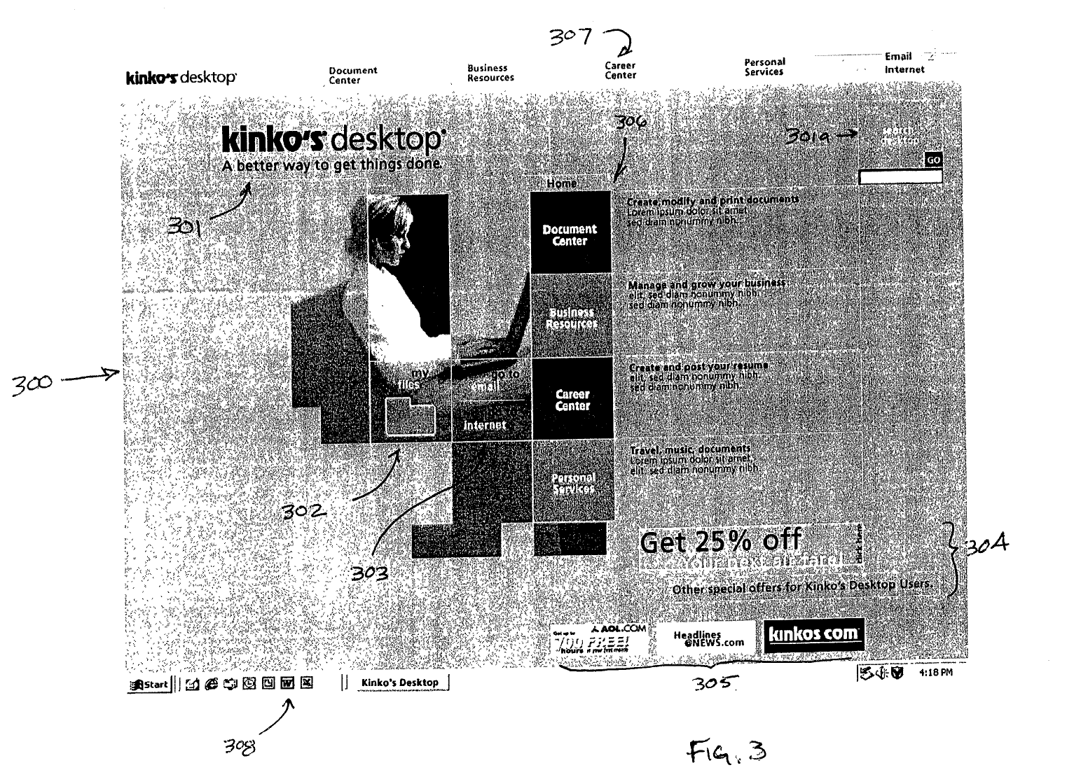

A sample of such a desktop is presented in FIG. 3 and is directed to the retailer Kinko's, the assignee of the present invention. Top level desktop 300 includes title 301, search space 301a, file storage area 302, and directional area 303 comprising a go to email link 303a and go to internet link 303b. The top level desktop 300 further includes promotional space 304, comprising a 25 per cent off airfare banner 304a and a special offer banner 304b, and advertising space 305. Advertising space 305 includes three advertisements 305a, 305b, and 305c, one each for AOL.com, News.com, and kinkos.com. The top level desktop 300 also includes operational space 306 including a document center selection 306a, business resource selection 306b, career center selection 306c, and personal services selection 306d. Each of these selections includes descriptive wording related to that selection for ease of use. Retailer specific toolbar 307 includes the four selections from operational space 306, while general toolbar 307 includes selectable icons for the machine in addition to a retailer desktop specific icon which may be selected to relocate to the desktop 300. Note that the toolbars to not form part of the desktop 300 per se, but are integrally related to the functionality and presentation thereof. The environment presented is a Microsoft Windows environment, but may be any operating system or environment offering the ability to selectively parse through multiple functional pages. The desktop software may be written in HTML, or may be written in some other appropriate language such that it gives the user the ability to navigate through the multiple functional pages by use of a user interface, such as a mouse or keyboard.

Note that FIG. 3 further includes an overbar 308 comprising the same selections as offered in operational space 306. These selections and this overbar remain at the top or other predetermined position of the screen to enable navigation between the available menus and submenus offered by the retailer. A user may select one of the selectable options on the overbar 308 and be directed to the appropriate predetermined program or submenu.

Selection of the buttons or icons located on the desktop transitions the user to different windows or programs. For example, in the embodiment shown in FIG. 3, a user selecting the “go to internet” function would be directed to a browser, and connection with the internet established, such that the user could download information stored on the internet, look up an answer to a question, or otherwise obtain information useful for her document preparation task. Likewise, selection of the “go to email” function would transition the user to an email program, such as Eudora or Microsoft Outlook, so that she could send a message or possibly review e-mail directed to her at this location.

A user who goes to the retailer for the first time is given a password, and storage area such that he or she can work from a remote location, such as work or home, and transmit information to and from computer drive space at the retailer. This is particularly useful when the user wishes to prepare a document at home and simply print it at the retail location. Alternately, the user may wish to store files at the retailer so he does not have to recreate document related information on subsequent visits. For example, a user may wish to print a manuscript for one group of people, such as close friends or associates, and a subsequent set of manuscripts for evaluation by a committee. Such a user could save the document, including margins, typesetting, fonts, and so forth, paper type and binding options at the retailer and print the subsequent set when appropriate using the temporary storage made available to him or her by the retailer.

Storage is preferably maintained by the retailer for a fixed period of time, such as one month or one year, depending on the storage available and the usage patterns of particular customers. Sufficient security via passwords and the like is provided such that the user can communicate with the storage space and place and retrieve information therefrom. Alternately, the user may only be able to access the drivespace when using a computer provided by the retailer. This can prove particularly useful when the retailer wishes to have the user store documents, settings, and so forth for return visits to retail locations.

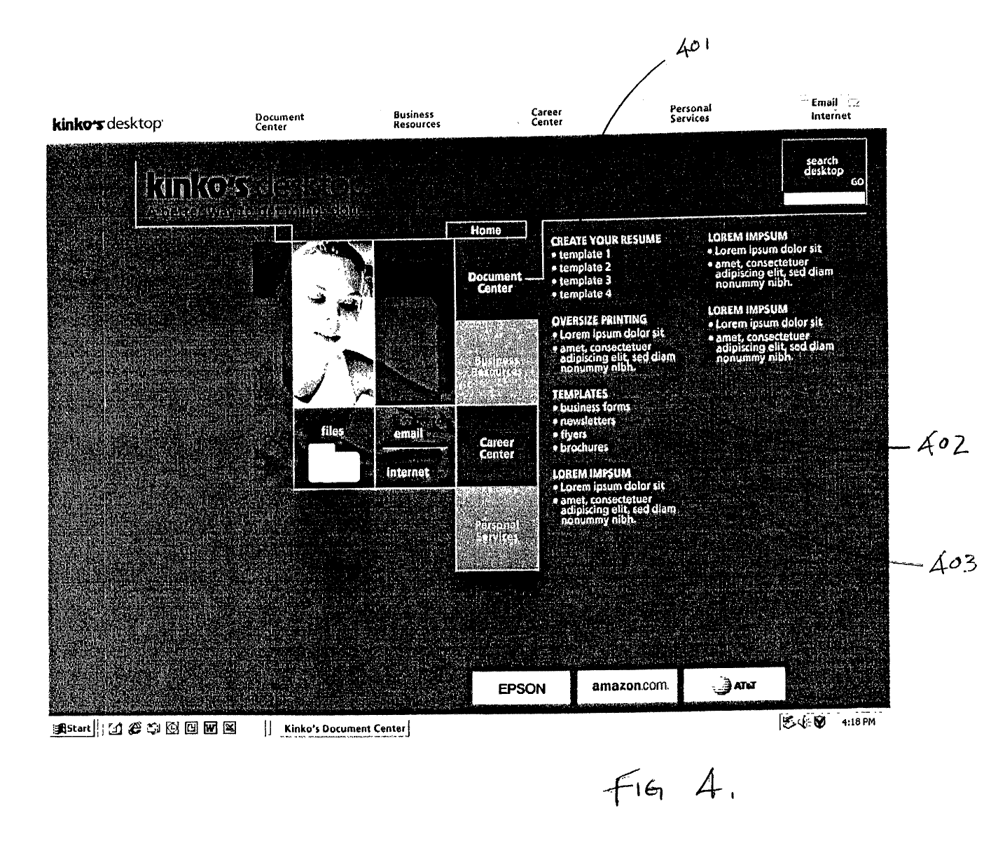

In FIG. 3, document center selection 306a provides a selectable space whereby the user can transition to a program or window to facilitate creation, editing, and printing of documents. A retailer may wish to simply transition the user to a default word processing program, such as Microsoft Word, when the user selects the document center selection 306a presented. Alternately, and as shown herein, selection of the document center selection 306a transitions the user to the window of FIG. 4, wherein the user can select from a variety of options depending on his or her needs. From FIG. 4, various general options are made available, including but not limited to Create your Resume 401, Oversize Printing, 402, and Templates 403. As shown, search, title, and advertising capability are also available at this level. It should be noted in this embodiment that the graphic style and general look is similar, but not identical, to the top level view 300.

Create your Resume option 401 enables a user to create a resume using a series of templates including styles for commonly used resumes. In the embodiment shown in FIG. 4, four templates may be presented which may include, for example, Computer employment resume, Corporate Executive resume, Educator resume, Part Time employment resume, or industry directed resumes, such as entertainment industry resume, restaurant/hotel resume, and so forth. Selection of one of the templates brings that template forward. A user selecting the “Create your Resume” option may alternately be directed to the default word processing program, where he or she can create or edit a new or existing resume. The Oversize Printing area 402 provides selections related to nonstandard printing capabilities, such as bindings, oversize documents, high quality paper, or other printing characteristics that are not available from a standard printer or copier. The Templates area offers a set of templates to the user, including a business form or forms, newsletters, flyers, brochures, and the like. These templates, as with the resumes, include a standardized document in a format compatible with a particular word processor and have text, margins, and so forth appropriate for that word processor. Other sections may be selected by the user as appropriate, including selections giving the user the ability to navigate to other menus or submenus or alternate programs, such as databases or document management programs. The options made available using the arrangement of FIG. 4 may be driven by usage statistics or user requests or by desired new offerings by the retailer. The result is the ability for the user to quickly and easily access the information and/or programs she desires.

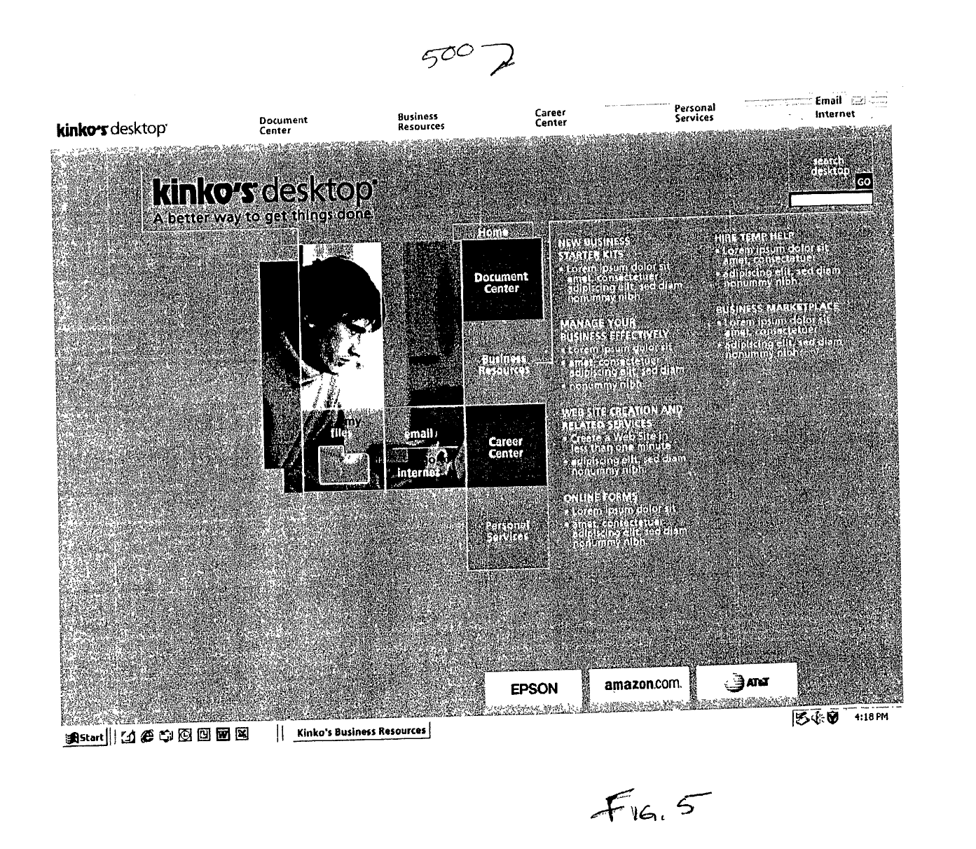

Selection of the business resource selection 306b of FIG. 3 directs the user to the screen depicted in FIG. 5. Workspace 500 includes the ability to retrieve files, go to email or internet, and perform a search, as well as includes the advertising found on the other screens discussed herein. Note that advertisements and/or discounts offered can change on different screens or remain the same depending on the desires of the retailer. The business resource page may optionally include an different graphics or color schemes and can offer the user the ability to select specific business related options, such as new business starter kits, management software, web site creation and related services, online forms, the ability to hire temporary help, and a business marketplace, the entirety of which may be displayed as shown or including additional or different options. A user selecting the web site creation option may be directed to web site preparation software, such as FrontPage, while a user selecting Online Forms may be directed to a fixed set of forms offered by the retailer or other entities via the internet. Selection of Hire Temp Help may direct the user to a form to be filled out specifying the help needed and other matters such as pay offered, time needed, skills sought, and so forth, or may direct the user to a web site offering persons looking for temporary employment. Thus while the page presented to the user is flexible in its design, it specifically directs the user to predetermined locations, selected by the retailer, useful in solving tasks facing a person likely to use the retailer's services.

The user selecting career center selection 306c may be presented with a screen similar to that shown in FIG. 7. Again, the general appearance and graphics are similar to the top level design, but differences may exist to differentiate the design, such as use of different colors or graphics. Searching capability and ability to retrieve files, connect to the internet, and send and receive email are present, as well as advertising, and the user is presented with an alternate set of selections, including a resume creation selection, a resume posting selection, a job search selection, an offer evaluation selection, and a job essentials selection. Note that certain areas may overlap other areas offered on other desktops, such as the resume creation selection. The resume creation selection may offer fixed templates or simply a general entry to a word processor. Resume posting may offer direct e-mails to known sites, while job searching may offer the ability to email a site and receive responses or directly access an internet site. Job essentials and offer evaluation may include helpful tips for searching for a job, including articles or other job searching information.

The personal services selection 306d may include various personal services either related or not related to the document production process, including locating deals on the internet or offered by the retailer, managing files, transferring money to pay for services, or other items made available to the user by the retailer. Such a situation is or may be readily changed by the retailer depending on the needs of users and desired services or products to be offered to the retail customer.

The present arrangement and design is implemented using standard HTML or other markup language code, and may also be composed of high level language code depending on circumstance and desire of the retailer.

While the invention has been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. A method for directing a computer user to preferred locations, said computer user employing a computer maintained by a third party, comprising:
providing a top level menu comprising document preparation related selections;
providing access to a personal storage area; and
providing at least one from a group comprising search, promotional, and advertising items.

2. The method of claim 1, wherein said document preparation related sections comprise a document creation option.

3. The method of claim 1, wherein said document preparation related sections comprises at least three sections.

4. The method of claim 1, wherein selection of one of said document preparation related selections directs the user to a submenu.

5. The method of claim 1, wherein selection of one of said document preparation related selections initiates a predetermined program.

6. The method of claim 1, further comprising directing the user to a submenu offering the user the ability to select at least one template.

7. The method of claim 1, further comprising providing an overbar present during navigation wherein said overbar includes said document preparation related selections.

8. A computer implemented method for directing a retail customer to a predetermined computing location, comprising the steps of:
providing a desktop area having limited choices relating to the retailer's business;
providing on said desktop area an area for user access to a personal storage area; and
providing on said desktop area a document navigation section enabling said user to select a subsection and be directed to an area pertaining to the business of the retailer.

9. The method of claim 8, wherein selection of said document navigation area directs the user to a submenu.

10. The method of claim 9, wherein said submenu includes the ability to select at least one template.

11. The method of claim 9, wherein said submenu includes the ability to select an option directing the user to a predetermined program.

12. The method of claim 8, wherein said retailer is engaged at least in part in the business of document production.

13. The method of claim 8, wherein said desktop further comprises at least one from the group comprising a search field, a promotional area, and an advertising area.

14. The method of claim 8, wherein said desktop further comprises an access area to the Internet.

15. The method of claim 8, further comprising providing at least one submenu enabling the user to access a predetermined set of programs and further submenus.

16. A method of doing business, comprising:
providing a customer with access to a computing device comprising a series of retailer business related menus, wherein said menus include a top level menu comprising a selection area offering a plurality of selectable regions directing a user to at least one from the group comprising a submenu and a computer program made available by the retailer; and
enabling said customer to navigate said menus and any submenus and programs to perform a task directed to said business.

17. The method of claim 16, wherein said top level menu further comprises an area for obtaining access to a storage area maintained by the retailer.

18. The method of claim 16, wherein said top level menu further comprises an area for accessing the internet.

19. The method of claim 16, further comprising enabling said user to access a predetermined set of templates relating to the business.

20. The method of claim 16, further comprising at least one from a group comprising a site search, promotional space, and advertising space.
